(19) United States
(12) Patent Application Publication
(10) Pub. No.: US 2005/0154055 A1
(43) Pub. Date: Jul. 14, 2005

(54) Method of stabilizing alkylenebisdithiocarbamates

(76) Inventors: Philippe Gouat, Haguenau (FR); Patrice Daniel Lemaitre, Marienthal (FR)

Correspondence Address: DOW AGROSCIENCES LLC, 9330 ZIONSVILLE RD, INDIANAPOLIS, IN, 46268, US

(21) Appl. No.: 11/036,955

(22) Filed: Jan. 14, 2005

Related U.S. Application Data
(60) Provisional application No. 60/536,699, filed on Jan. 14, 2004.

(51) Int. Cl. A01N 47/10

(52) U.S. Cl. 514/479

(57) ABSTRACT

A method of stabilizing an alkylenebis dithiocarbamate comprising contacting the alkylenebis dithiocarbamate with an inert gas, de-aerating the alkylenebis dithiocarbamate and packaging the alkylenebis-dithiocarbamate in an air-tight container.

The present invention relates to a method of stabilizing alkylenebis dithiocarbamate compounds, which are useful as fungicides.

### BACKGROUND

Alkylenebis dithiocarbamates are known compounds found to be useful in preventing and protecting plants from various diseases. These compounds are typically in the form of granules or powders which can be packaged in micro perforated bags designed for air exchange, or air tight bags. However, such dithiocarbamates are also known to have impurities or by-products of degradation, such as ethylenethiourea (ETU), which develops from the degradation of the dithiocarbamate over time. In order to mitigate these impurities, stabilizing agents have been added and/or the product has been vacuum packed to prevent degradation. However, stability agents increase cost and vacuum packaging can only be used for powders with expensive specialized equipment due to the very small particle sizes. U.S. Pat. No. 5,389,674 discloses a method of obtaining increased stability by providing an effective amount of moisture to significantly enhance the flowability and reduce the ETU content of the composition. However, the added moisture content causes some degree of degradation, thus reducing the amount of active ingredient. Therefore, there continues to be a need for fungicidal alkylenebis dithiocarbamate compositions with improved stability and less by-product formation.

### SUMMARY

The present invention is directed to a method of stabilizing alkylenebis-dithiocarbamates, comprising using an inert gas to transport, cool and de-aerate the dithiocarbamate prior to sealing the dithiocarbamate within an air tight container, such that degradation and the formation of by-products, specifically alkylenethiourea, such as ethylenethiourea, is significantly decreased; and the product produced therefrom.

### DETAILED DESCRIPTION

The dithiocarbamate embodied within the present invention is an alkylenebis dithiocarbamate, and is preferably selected from ethylenebisdithiocarbamate metal salts. Preferred ethylene bisdithiocarbamate metal salts are mancozeb (a coordination product of zinc and manganese ethylenebisdithiocarbamate), maneb (manganese ethylenebisdithiocarbamate), metiram (tris[amine-[ethylene bis(dithiocarbamate)]-zinc(II)[tetrahydro-1,2,4,7-dithiadia-zocine-3,8-dithione]polymer) and zineb (zinc ethylenebisdithiocarbamate).

The method of the present invention is useful for any solid form of the dithiocarbamate, including dispersible granule, dust, powder formulations, and the like.

In one embodiment, the dithiocarbamate is in the form of a wettable powder, which may be agglomerated to form water dispersible granules, comprising an intimate mixture of the dithiocarbamate, inert diluents and agriculturally acceptable surfactants. The concentration of the dithiocarbamate in the wettable powder is usually from about 10% to about 90% by weight, more preferably about 25% to about 90% by weight, based on the total weight of the wettable powder.

In the preparation of wettable powder formulations, the dithiocarbamate can be finely divided by mechanical grinding and then mixed with inert diluents and surfactants.

Effective surfactants, comprising from about 0.5% to about 10% by weight of the total weight of the wettable powder, include sulfonated lignins, naphthalenesulfonates, alkylbenzenesulfonates, alkyl sulfates, and non-ionic surfactants, such as ethylene oxide adducts of alkyl phenols.

In another embodiment, the dithiocarbamate is a granular formulation, which is particularly useful for applications to the soil. Granular formulations usually contain from about 0.5% to about 10% by weight, based on the total weight of the formulation, of the dithiocarbamate, dispersed in a carrier which consists entirely or in large part of coarsely divided attapulgite, bentonite, diatomite, clay or a similar inexpensive substance. Such formulations are usually prepared by dispersing the dithiocarbamate in a suitable solvent and applying it to a granular carrier which has been preformed to the appropriate particle size, in the range of from about 0.5 to about 3 mm. Such formulations may also be prepared by making a dough or paste of the carrier and the dithiocarbamate, and crushing and drying to obtain the desired granular particle.

In yet another embodiment, the dithiocarbamate may be in the form of a dust containing the dithiocarbamate, which is prepared by intimately mixing the dithiocarbamate in powdered form with a suitable dusty agricultural carrier, such as, for example, kaolin clay, ground volcanic rock, and the like. Dusts can suitably contain from about 1% to about 10% by weight of the combination.

The formulations may optionally include combinations that can comprise at least 1% by weight, based on the total weight of the combination, of one or more dithiocarbamates with an additional pesticide compound. Such additional pesticide compounds may be fungicides, insecticides, nematocides, miticides, arthropodicides, bactericides or combinations thereof, that are compatible with the dithiocarbamate of the present invention in the medium selected for application, and not antagonistic to the activity of the present compounds. Accordingly, in such embodiments the other pesticide compound is employed as a supplemental toxicant for the same or for a different pesticidal use. The pesticide compound and the dithiocarbamate can generally be mixed together in a weight ratio of from 1:100 to 100:1.

In the process of the present invention, the solid product comprising the dithiocarbamate is introduced into a packaging process, wherein the dithiocarbamate is contacted with inert gas and transported via inert gas flow. The dithiocarbamate is typically contacted with an inert gas within an enclosed area. An enclosed area is an area in which the inert gas can be introduced and increasingly concentrated such that minimum inert gas is lost. The enclosed area can comprise for example, a pipe for transport, a storage container, a hopper or silo, and/or an air-tight container. The inert gas may be any inert gas which will transport the dithiocarbamate via, for example pneumatic transfer, and provide stability such that dithiocarbamate degradation and the level of ETU is significantly decreased. A significant reduction in ETU is a reduction of at least 20% or more, based on the amount of ETU produced in the absence of inert gas. Preferably the inert gas is selected from carbon dioxide (CO₂), nitrogen and argon, or any combination thereof. Most preferably, the inert gas is CO₂ due to its high molecular weight and improved cooling effect on the dithiocarbamate during transfer. In one embodiment, the gas is a mixture of CO₂ and nitrogen, wherein nitrogen is from 1, preferably from 5, more preferably from 10 to 40, preferably to 45, more preferably to 50, percent based on the total volume of the gas mixture.

The dithiocarbamate is mixed with an inert gas thus removing a large amount of oxygen in contact with the dithiocarbamate. The dithiocarbamate/inert gas mixture is then deposited in a container which can be sealed such that air or other gases cannot further exchange with the inert gas atmosphere within the container. In other words, the container is air-tight after sealing. Prior to sealing the air-tight container, the dithiocarbamate is typically further de-aerated with inert gas, substantially removing all other gases. De-aeration can be achieved by any method which substantially replaces air with the inert gas.

In one embodiment (Embodiment I) of the present invention, an inert gas is introduced to the dithiocarbamate during a dithiocarbamate transfer process, wherein the dithiocarbamate is being transported from one location to another within a process. The inert gas is introduced at an adequate rate, depending upon the conveying system capacity and the transfer distance, thus replacing the atmospheric air and forming a dilute phase transfer system. The dilute phase transfer system is a combination of the dithiocarbamate with the inert gas to form a fluidized dithiocarbamate/inert gas mixture which can easily flow. Such methods and dilute phase transfer system would be easily ascertainable to one skilled in the art. The dithiocarbamate and inert gas are then collected in a receiving hopper, and excess gas is separated from the dithiocarbamate and filtered before being released to the atmosphere, thus assuring the hopper inertization. In the same receiving hopper, extra inert gas additions are provided, and the remaining oxygen content is monitored on a continuous basis by a dedicated gas analyzer. The average oxygen level within the hopper, prior to packaging is typically 0.9% or less, preferably 0.8% or less, more preferably 0.7% or less and most preferably 0.6% or less, based on the total gas composition.

The dithiocarbamate/inert gas mixture is then transferred using the dilute phase transfer system to a buffering hopper. The dithiocarbamate is then transferred to a bagging machine hopper via a vacuum de-aeration screw to remove the remaining gas and densify the dithiocarbamate product. The dithiocarbamate/inert gas mixture is then transferred via dosing screws to deliver the dithiocarbamate/inert gas mixture into the bag. Typically, the mixture is delivered at a location within the bag which is just above the dithiocarbamate level already deposited in the bag to avoid air entrapment during filling. In other words, either the bag or dosing screw(s) are continuously positioned in such a way that there is not a significant distance between the outlet of the dosing screw and the uppermost level of the dithiocarbamate product already deposited in the bag. Therefore, either the dosing screw(s) is raised as the bag is filled, or the bag is lowered.

Once filled, the bag is transferred to a first de-aeration station where vacuum rods are introduced into the bag, to remove the remaining gas. In a second de-aeration stage, the top of the bag is pressed and closed, and a suction probe is introduced in the top of the bag (above the product level) to continue extracting the remaining gas.

The bag top is kept closed mechanically to prevent re-aeration and transferred to the bag closing station where the bag is folded and heat sealed to provide an air tight seal.

Typically, the inert gas comprises at least 99.0% of the atmosphere surrounding the dithiocarbamate within the air-tight container.

The container can be any container which can be sealed, thus preventing the escape of inert gas and the introduction of other gases within the container. Typically, the container is a heat sealable bag with a means to prevent gas transfer. Such bags typically comprise a plastic liner within a multi-ply paper bag, such as 3-ply KRAFT™ paper, although other materials can also be used, such as foils. The plastic liner is typically produced from polymeric materials such as polyethylene, high or low density polypropylene, or polyethylene-ethylene vinyl alcohol, (PE/EVOH). The bag is then typically folded (e.g. double folded) and heat sealed.

The transport and packaging process can be completed using any process which will introduce an inert gas and store the dithiocarbamate such that stability is increased and the production of by-products is reduced. In one embodiment, a CHRONO-FILL™ PBS 2001 BFW packaging line is used, available from BMH Chronos Richardson.

The process of the present invention gives surprisingly good stability to the dithiocarbamates, significantly decreasing the amount of degradation and the by-production of the alkylene thiourea. Typically, the amount of ETU is decreased by at least 30%, preferably at least 40% and most preferably at least 45%, based on the amount of degradation which occurs in the absence of inert gas, after 2 months of storage. Generally, the amount of active ingredient degradation is less than 1 percent, preferably less than 0.5 percent, more preferably less than 0.4 percent and most preferably less than 0.3 percent, based on the total original amount of dithiocarbamate.

### EXAMPLES

The following examples are provided to illustrate the present invention. The examples are not intended to limit the scope of the present invention and they should not be so interpreted. Amounts are in weight parts or weight percentages unless otherwise indicated.

### Examples 1 and 2

Ethylenebis dithiocarbamate was produced and packaged in 25 kg. bags using a CHRONO-FILL™ PBS 2001 BFW according to the process as described in Embodiment I of the present specification.

% Active Ingredient was Determined According to the Following:

The procedure (issued from CIPAC methods) is based on the decomposition of the 0.2 to 0.3 g of sample (ethylene bis dithiocarbamate-EBDC) (tracking based on the evolution of carbon disulfide 1 EBDC<=>2CS₂) when heated with dilute sulfuric acid (2N) for 105 minutes. The liberated gas is aspired through an absorber containing lead acetate solution to remove hydrogen sulfide formed during the decomposition of the sample. The carbon disulfide is then absorbed in chilled (0-5° C.) methanolic potassium to form potassium xanthate. This solution is neutralized with acetic acid, then titrated with 0.1 N iodine solution to the starch end point. The temperature of the absorber (0° C.-5° C.) must be regulated throughout the determination.

% Ethylene Thiourea (ETU) (2-Imidazolidinethione) was Determined According to the Following:

ETU is extracted through addition, in equal quantity, of a 4% zinc chloride solution to a solution of EBDC (100 mg EBDC/10 ml H₂O) in deionized water. ETU is then separated through HPLC (liquid chromatography) & compared to calibrated solutions. The solvent is a 5% acetonitrile solution in deionized water. ETU is detected by a UV spectrophotometer, visible at 233 nm.

The CIPAC (official ref std) method references are: CIPAC method MT 61/TC/M/-3, CIPAC Handbook E, page 116.

At the designated time, a 50 g sample was removed from the bag and analyzed immediately.

The bags were stored in a ventilated oven at 54° C.

PERCENT ACTIVE INGREDIENT

| | Weeks of Storage | | | |
|---|---|---|---|---|
| Sample | 0 | 2 | 4 | 6 |
| Std. 1 | 83.7 | 82.5 | 82.1 | 80.7 |
| Std. 2 | 81.8 | 81.6 | 81.3 | 80.7 |
| Example 1 | 83.6 | 82.9 | 82.7 | 82.8 |
| Example 2 | 82.3 | 82.3 | 82.6 | 82.4 |

Std 1 is Dithane ™ M45 lot #RG2988R232 packed in micro perforated bags with no inert gas.
Std 2 is Dithane ™ M45 lot #RJ2788R23 I packed in micro perforated bags with no inert gas.
Example 1 is Dithane ™ M45 lot # RG2988R232 packed in air-tight polyethylene/EVOH bags.
Example 2 is Dithane ™ M45 lot # RJ2788R231 packed in air-tight polyethylene liner bags.

PERCENT ETHYLENETHIOUREA

| | Weeks of Storage | | | |
|---|---|---|---|---|
| Sample | 0 | 2 | 4 | 6 |
| Std. 1 | 0.10 | 0.11 | 0.12 | 0.14 |
| Std. 2 | 0.07 | 0.12 | 0.13 | 0.15 |
| Example 1 | 0.12 | 0.07 | 0.07 | 0.07 |
| Example 2 | 0.08 | 0.09 | 0.08 | 0.08 |

Std 1 is Dithane ™ M45 lot ##RG2988R232 packed in micro perforated bags with no inert gas.
Std 2 is Dithane ™ M45 lot # RJ2788R231 packed in micro perforated bags with no inert gas.
Example 1 is Dithane ™ M45 lot ##RG2988R232 packed in air-tight Polyethylene/EVOH bags.
Example 2 is Dithane ™ M45 lot # RJ2788R231 packed in air-tight polyethylene liner bags.

The process of the present invention surprisingly reduces the amount of by-product produced during storage of the dithiocarbamate and offers increased stability with lower product degradation.

1. A method of stabilizing an alkylenebis dithiocarbamate, useful as a fungicide, from degradation and formation of unwanted by-products comprising:
a) contacting the alkylenebis dithiocarbamate with an inert gas in an enclosed area,
b) de-aerating the enclosed area containing the alkylenebis dithiocarbamate, and
c) packaging the alkylenebis dithiocarbamate in an air-tight container.

2. The method of claim 1 wherein the alkylenebis dithiocarbamate is selected from ethylenebisdithiocarbamate metal salts.

3. The method of claim 2 wherein the alkylenebis dithiocarbamate is selected from mancozeb (a coordination product of zinc and manganese ethylenebisdithiocarbamate), maneb (manganese ethylenebisdithiocarbamate), metiram (tris[amine-[ethylene bis(dithiocarbamate)]- zinc(II)[tetrahydro-1,2,4,7-dithiadia-zocine-3,8-dithione]polymer) and zineb (zinc ethylenebisdithiocarbamate).

4. The method of claim 1 wherein the inert gas is CO₂.

5. The method of claim 4 wherein the inert gas is a combination of CO₂ and nitrogen.

6. The method of claim 1 wherein the air-tight container is a bag.

7. An air-tight container containing an inert gas and a composition comprising an alkylenebis dithiocarbamate, wherein the inert gas comprises at least 99.0% of the atmosphere surrounding the alkylene bis dithiocarbamate within the air-tight container.

8. The air-tight container of claim 1 wherein the alkylenebis dithiocarbamate is selected from ethylenebisdithiocarbamate metal salts.

9. The air-tight container of claim 2 wherein the alkylenebis dithiocarbamate is selected from mancozeb (a coordination product of zinc and manganese ethylenebisdithiocarbamate), maneb (manganese ethylenebisdithiocarbamate), metiram (tris[amine-[ethylene bis(dithiocarbamate)]-zinc(II)[tetrahydro-1,2,4,7-dithiadia-zocine-3,8-dithione]polymer) and zineb (zinc ethylenebisdithiocarbamate).

10. The air-tight container of claim 1 wherein the inert gas is CO₂.

11. The air-tight container of claim 7 wherein the inert gas is a combination of CO₂ and nitrogen.

12. The air-tight container of claim 1 wherein the air-tight container is a bag.
